(19) United States
(12) Patent Application Publication
(10) Pub. No.: US 2021/0272589 A1
(43) Pub. Date: Sep. 2, 2021

(54) Degausser Mechanism Utilizing Magnetic Fluid for Destroying the Functionality of Data Bearing Components of Magnetic Media Data Bearing Devices

(71) Applicant: Sepehr Rajaie, Reynoldsburg, OH (US)

(72) Inventor: Sepehr Rajaie, Reynoldsburg, OH (US)

(21) Appl. No.: 17/139,923

(22) Filed: Dec. 31, 2020

Related U.S. Application Data
(60) Provisional application No. 62/982,948, filed on Feb. 28, 2020.

(51) Int. Cl. G11B 5/024

(52) U.S. Cl. CPC G11B 5/0245

(57) ABSTRACT

The current invention is a Degausser Mechanism Utilizing Magnetic Fluid for Destroying the Functionality of Data Bearing Components of Magnetic Media Data Bearing Devices. This degausser mechanism utilizing magnetic fluid provides reconciliation and tracking with a unique identification tag using a secure database of the provider of the degausser mechanism utilizing magnetic fluid. This degausser mechanism utilizing magnetic fluid provides destruction of the functionality of the data bearing components of magnetic media data bearing devices, and containment of the remains of the magnetic media devices with the functionality of data destroyed onsite by the user until auditing. This degausser mechanism utilizing magnetic fluid is portable and is intended to be used in small enterprise offices or other locations.

### CROSS-REFERENCES TO RELATED APPLICATIONS (IF ANY)

This application claims the priority date of Provisional Application 62/982,948 filed on Feb. 28, 2020.

### BACKGROUND

### 1. Field of the Invention

The present invention relates to mechanism for Utilizing Magnetic Fluid for Destroying the Functionality of Data Bearing Components of Magnetic Media Data Bearing Devices

### 2. Description of Prior Art

Magnetic media data bearing devices that eventually fail or are decommissioned are separated from the computer device and need to have the functionality of the data bearing components destroyed so that the data is no longer usable. This process must be verified to meet cyber security regulations.

Other systems may not provide reconciliation and tracking of devices during the data destruction process. Other systems may not be intended for use with magnetic media data bearing devices that have had changes in their characteristics. Other systems may not be modifiable to meet changes made to cyber security regulations. Other systems may not process magnetic media data bearing devices in a time saving manner. Other systems may not be intended for use in small enterprise offices or other locations. Other systems may not provide auditing and issuing of Certificates of Destruction for their processes.

There is still room for improvement in the art.

### SUMMARY OF THE INVENTION

The present invention is a degausser mechanism utilizing magnetic fluid that provides reconciliation and tracking with a unique identification tag using a secure database of the provider of the degausser mechanism utilizing magnetic fluid.

This degausser mechanism utilizing magnetic fluid provides destruction of the functionality of the data bearing components of magnetic media data bearing devices, and containment of the remains of the magnetic media devices with the functionality of data destroyed onsite by the user until auditing. This degausser mechanism utilizing magnetic fluid is portable and is intended to be used in small enterprise offices or other locations. This degausser mechanism utilizing magnetic fluid has components that are modular and can be modified based on changes in the characteristics of magnetic media data bearing devices and changes in the cyber security regulations for data destruction. This degausser mechanism utilizing magnetic fluid provides for auditing and issuing of Certificates of Destruction for their processes.

It is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows a diagram of some of the components of the invention; and

FIG. 2 shown a flowchart of the invention.

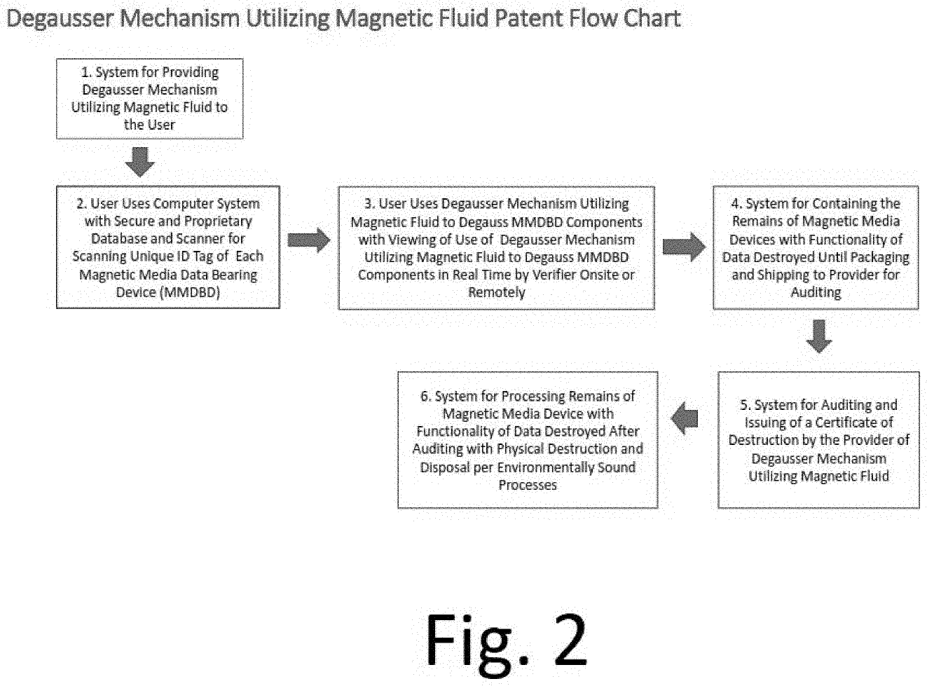

### DESCRIPTION OF THE PREFERRED EMBODIMENT

There are a number of significant design features and improvements incorporated within the invention.

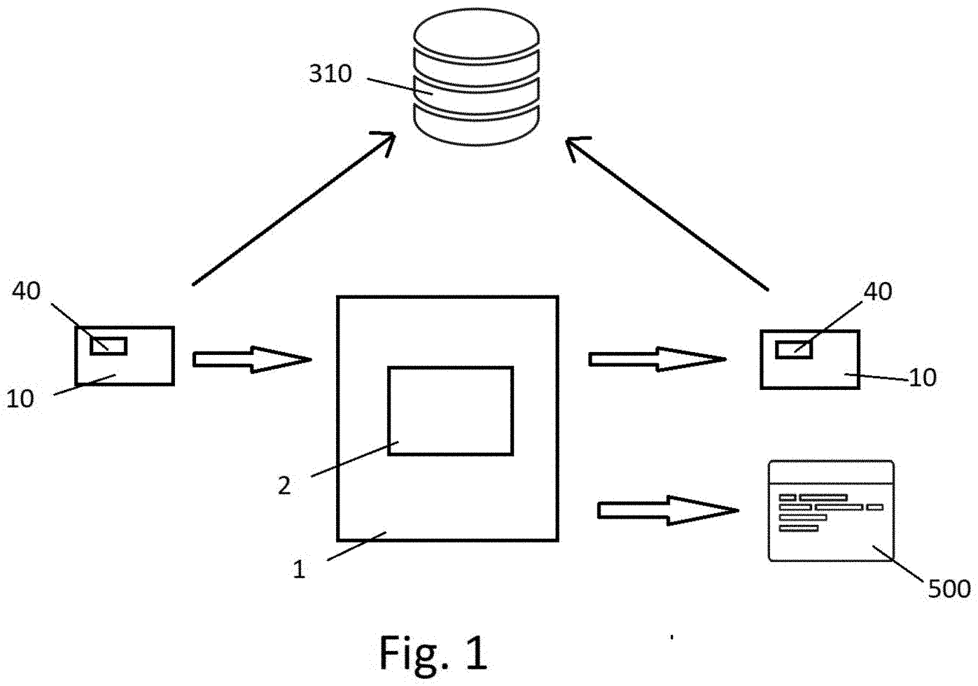

As shown in FIG. 1, the current invention is a process of the sanitizer using the degausser mechanism 1 utilizing magnetic fluid 2 to destroy the functionality of the data bearing components.

Magnetic media data bearing devices 10 that eventually fail or are decommissioned are separated from a computer device and need to have the functionality of the data bearing components destroyed so that the data is no longer usable. This process must be verified to meet cyber security regulations. The invention claimed here solves this problem.

When the failed or decommissioned magnetic media data bearing device 10 is removed from a computer device and is designated for destruction of data, it will be reconciled and tracked by being enrolled into the secure database 310 of the provider of the degausser mechanism 1 utilizing magnetic fluid 2 and assigned a unique identification tag 40. It will be processed using the degausser mechanism 1 utilizing magnetic fluid 2.

After this process is completed and verified, the magnetic media data bearing device 10 with the functionality of the data bearing components destroyed onsite with the user will be contained by the user until being packaged and shipped to the provider of the degausser mechanism 1 utilizing magnetic fluid 2 for auditing through a secure database. A Certificate of Destruction 500 will be issued and the magnetic media data bearing device 10 with the functionality of the data bearing components destroyed onsite with the user will be physically destroyed by the provider of the degausser mechanism 1 utilizing magnetic fluid 2 and will be disposed of following environmentally sound processes.

This degausser mechanism 1 utilizing magnetic fluid 2 is anticipated to be able to be used in small enterprise offices or other locations. The components of this degausser mechanism 1 utilizing magnetic fluid 2 are modular and can be modified based on changes in the characteristics of magnetic media products and changes in the cyber security regulations for data destruction.

This invention is an improvement on what currently exists. This degausser mechanism 1 utilizing magnetic fluid 2 provides reconciliation and tracking with a unique identification tag 40 using a secure database, processing to destroy the functionality of the data bearing components of magnetic media data bearing devices 10 using a degausser mechanism 1 utilizing magnetic fluid 2 that has been certified by a third-party test lab to meet NSA standards for data destruction on magnetic media, and containment with the user of the remains of magnetic media devices 10 with the functionality of the data bearing components destroyed onsite with the user until auditing. This degausser mechanism 1 utilizing magnetic fluid 2 is anticipated to be able to be used in small enterprise offices or other locations. The components of this degausser mechanism 1 utilizing magnetic fluid 2 are modular and can be modified based on changes in the characteristics of magnetic media products and changes in the cyber security regulations for data destruction.

### Process

Step 1-6 are completed in order as listed. Step 1 begins the process of providing the degausser mechanism 1 utilizing magnetic fluid 2 product to the user. Step 2 is when the magnetic media data bearing device 10 has its unique identification tag 40 scanned into the database 310 by the user. Step 3 is when the degausser mechanism 1 utilizing magnetic fluid 2 is performed onsite by the user and verified in real time onsite or remotely by the verifier. Step 4 is the containment by the user of the magnetic media that has the functionality of the data destroyed until packaging and shipping to the provider of the degausser mechanism 1 utilizing magnetic fluid 2 for auditing. Step 5 is the system for auditing and issuing of a Certificate of Destruction 500 by the provider of the degausser mechanism 1 utilizing magnetic fluid 2. Step 6 is processing of the remains of the magnetic media device that has the functionality of the data destroyed after auditing with physical destruction and disposal per environmentally sound processes.

Other systems do not reconcile and track devices 10 during the data destruction process. Other systems do not destroy the functionality of data bearing components on magnetic media data bearing devices 10. Other systems do not destroy the functionality of data bearing components on magnetic media data bearing devices 10 onsite with the user. Other systems do not process data bearing devices 10 in small enterprise offices or other locations. Other systems do not destroy data in a time saving manner. Other systems are not modifiable for use with magnetic media data bearing devices 10 that have had changes in their characteristics. Other systems are not modifiable to meet changes made to cyber security regulations. Other systems do not provide auditing and issuing of Certificates of Destruction 500 for their processes.

### Advantages

The current invention can produce a new method to destroy the functionality of data on magnetic media data bearing devices and a new method for users to have their process of destroying the functionality of data on magnetic media data bearing devices verified and audited.

### CONCLUSION

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device of destroying data bearing devices:
a mechanism using magnetic fluid to destroy the data bearing devices.

2. A device according to claim 1 further comprising:
said having a identification tag.

3. A device according to claim 2 further comprising:
where said identification tag is scanned into a database.

4. A device according to claim 3 further comprising:
reconciliation and tracking the identification tag.

5. A device according to claim 4 further comprising:
using a secure database.

6. A device according to claim 1 further comprising:
having the device be modular.

7. A device according to claim 1 further comprising:
modifying the device base on the data bearing device.

8. A device according to claim 1 further comprising:
issuing a Certificate of Destruction.

9. A device according to claim 1 further comprising:
where the data bearing devices will be tracked and reconciled by a database.

10. A process to destroy data using the device of claim 1.
